(19) United States
(12) Patent Application Publication
(10) Pub. No.: US 2025/0300716 A1
(43) Pub. Date: Sep. 25, 2025

(54) BASE STATION DEVICE, TERMINAL DEVICE, AND WIRELESS COMMUNICATION SYSTEM

(71) Applicant: Fujitsu Limited, Kawasaki-shi (JP)

(72) Inventors: Tetsuya YANO, Yokohama (JP); YOSHIHIRO KAWASAKI, Kawasaki (JP); Yosuke AKIMOTO, Ichihara (JP)

(73) Assignee: Fujitsu Limited, Kawasaki-shi (JP)

(21) Appl. No.: 19/228,949

(22) Filed: Jun. 5, 2025

Related U.S. Application Data
(63) Continuation of application No. PCT/JP2022/047246, filed on Dec. 21, 2022.

(51) Int. Cl. H04B 7/06; H04L 1/00

(52) U.S. Cl. CPC H04B 7/06952; H04L 1/0003

(57) ABSTRACT

A base station device that wirelessly communicates with a terminal device, the base station device includes processor circuitry configured to set a plurality of beams that candidates for the terminal device as candidate beams for signal transmission/reception; transmit a signal having a same content using the plurality of beams that is the candidate beams; receive a response signal from the terminal device that has received the signal transmitted using any beam of the plurality of beams; and update the candidate beams.

### CROSS-REFERENCE TO RELATED APPLICATION

This application is a continuation of International Application No. PCT/JP2022/047246, filed on Dec. 21, 2022, the entire contents of which are incorporated herein by reference.

### FIELD

The embodiments discussed herein are related to a base station device, a terminal device, and a wireless communication system.

### BACKGROUND

In recent years, in a wireless communication system using a high frequency, a method of covering areas in respective directions using a plurality of beams generated by beam forming has been used. Even when the terminal moves in the area across the beam, the base station tracks the movement of the terminal.

In Rel-17 of the current 5G standard specification, for example, control information and user data are transmitted from a maximum of two transmit/receive points on the base station side by a multiple transmit/receive point (multi-TRP) operation. As a result, it is possible to improve communication coverage, communication reliability, a communication data rate, and the like.

In addition, in the beam management of the 5G standard specification, an SSB (synchronization signal (SS)/physical broadcast channel (PBCH) block)/channel state information (CSI) resource is designated from the base station to the terminal. As a result, the base station may set, by means of the SSB/CSI resource, a target cell beam to be monitored for measurement reporting for the terminal. The SSB is a block of a synchronization signal transmitted from the base station. A CSI-Reference Signal (RS) is a reference signal for measuring a channel state.

In Rel-17 of the 5G standard specification (see, for example, Non Patent Literature 11 to 25), information related to a cell for maintaining synchronization with a base station (cell or beam), a sub-band (Bandwidth Part) in a band set for a terminal for use in transmission and reception of a signal in a system band, and a CSI-RS is set by transmission configuration indicator (TCI). Furthermore, in Rel-17, information about SSB and Quasi Co-Location (QCL)-Type which is similarity of propagation paths is described.

When the Multi-TRP is applied, the terminal is connected to a maximum of two TRPs on the base station side, and can independently transmit and receive different control information and user data to and from each TRP. In addition, the terminal can transmit and receive the same control information and user data to and from each TRP.

In addition, 3GPP (registered trademark) TS 38.300 (Non Patent Literature 21) describes scheduling of multi-TRP physical downlink shared channel (PDSCH) transmission. Multi-TRP PDSCH scheduling includes two types of operation modes: a single downlink control information (DCI) mode and a multi-DCI mode. Uplink control and downlink control by the physical layer and the MAC layer are also possible in the single DCI mode and the multi-DCI mode within a range of setting provided by a radio resource control (RRC) layer. In the single DCI mode, data of both TRPs is scheduled by the same DCI for the terminal. In addition, in the multi-DCI mode, data of each TRP is scheduled by the DCI independent of each TRP (between TRPs) for the terminal.
Patent Literature 1: International Publication Pamphlet No. WO 2019/031133
Patent Literature 2: Japanese Laid-open Patent Publication No. 2007-259044
Patent Literature 3: Japanese Laid-open Patent Publication No. 2017-143422
Non Patent Literature 1: 3GPP TS 36.133 V17.6.0
Non Patent Literature 2: 3GPP TS 36.211 V17.2.0
Non Patent Literature 3: 3GPP TS 36.212 V17.1.0
Non Patent Literature 4: 3GPP TS 36.213 V17.2.0
Non Patent Literature 5: 3GPP TS 36.214 V17.0.0
Non Patent Literature 6: 3GPP TS 36.300 V17.1.0
Non Patent Literature 7: 3GPP TS 36.321 V17.1.0
Non Patent Literature 8: 3GPP TS 36.322 V17.0.0
Non Patent Literature 9: 3GPP TS 36.323 V17.1.0
Non Patent Literature 10: 3GPP TS 36.331 V17.1.0
Non Patent Literature 11: 3GPP TS 37.324 V17.0.0
Non Patent Literature 12: 3GPP TS 37.340 V17.1.0
Non Patent Literature 13: 3GPP TS 38.133 V17.6.0
Non Patent Literature 14: 3GPP TS 38.201 V17.0.0
Non Patent Literature 15: 3GPP TS 38.202 V17.2.0
Non Patent Literature 16: 3GPP TS 38.211 V17.2.0
Non Patent Literature 17: 3GPP TS 38.212 V17.2.0
Non Patent Literature 18: 3GPP TS 38.213 V17.2.0
Non Patent Literature 19: 3GPP TS 38.214 V17.2.0
Non Patent Literature 20: 3GPP TS 38.215 V17.1.0
Non Patent Literature 21: 3GPP TS 38.300 V17.1.0
Non Patent Literature 22: 3GPP TS 38.321 V17.1.0
Non Patent Literature 23: 3GPP TS 38.322 V17.1.0
Non Patent Literature 24: 3GPP TS 38.323 V17.1.0
Non Patent Literature 25: 3GPP TS 38.331 V17.1.0

In a wireless communication system, when a cover area is formed by beamforming, it is important to suppress interruption of a communication link accompanying movement of a terminal and to maintain the communication link. In a wireless communication system, an area tends to be divided into thinner beams as a frequency used for wireless communication increases.

However, in the base station, the communication link between the base station and the terminal may be interrupted when the position of the terminal grasped by the base station and the position where the terminal is actually present are in different beam directions depending on the conditions of the CSI reporting cycle from the terminal and the moving speed of the terminal. For example, in a case where Discontinuous Reception (DRX) is applied, there is a high possibility that the terminal moves across a plurality of beams while the reception is OFF, and thus, there is a high possibility that the communication link between the terminal and the base station is interrupted. Note that such a problem is more remarkable as the frequency used for wireless communication is higher.

### SUMMARY

According to an aspect of an embodiment, a base station device wirelessly communicates with a terminal device. The base station device includes processing circuitry configured to
set a plurality of beams that is candidates for the terminal device as candidate beams for signal transmission/reception. The processing circuitry is configured to transmit a signal having a same content using the plurality of beams that is the candidate beams. The processing circuitry is configured to receive a response signal from the terminal device that has received the signal transmitted using any beam of the plurality of beams, and update the candidate beams.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is an explanatory diagram illustrating an example of a wireless communication system of the present embodiment;

FIG. 2 is a block diagram illustrating an example of a functional configuration of a terminal;

FIG. 3 is a block diagram illustrating an example of a functional configuration of a base station;

FIG. 4 is a block diagram illustrating an example of a functional configuration of a transmission data processing unit, a transmission BB processing unit, and a wireless communication circuit;

FIG. 5 is a sequence diagram illustrating an example of a processing operation related to a communication process of the wireless communication system;

FIG. 6 is a flowchart illustrating an example of a processing operation of a base station related to a setting process;

FIG. 7 is an explanatory diagram illustrating an example of a table for setting the number of candidate beams according to a beam width;

FIG. 8 is an explanatory diagram illustrating an example of setting the number of candidate beams according to a beam width;

FIG. 9 is an explanatory diagram illustrating an example of a table for setting the number of candidate beams according to a moving speed of a terminal;

FIG. 10 is an explanatory diagram illustrating an example of setting the number of candidate beams according to a moving speed of a terminal;

FIG. 11 is an explanatory diagram illustrating an example of a table for setting the number of candidate beams according to how frequently a data transmission to a terminal occurs;

FIG. 12 is an explanatory diagram illustrating an example of setting the number of candidate beams according to how frequently a data transmission to a terminal occurs;

FIG. 13 is an explanatory diagram illustrating an example of a table for setting the number of candidate beams according to a comprehensive coefficient;

FIG. 14 is a flowchart illustrating an example of a processing operation of a base station related to a transmission process;

FIG. 15 is an explanatory diagram illustrating an example of the resource for mapping a control channel and a data channel of each candidate beam;

FIG. 16 is a flowchart illustrating an example of a processing operation of a terminal related to a reception process;

FIG. 17 is a flowchart illustrating an example of a processing operation of a terminal related to a response process;

FIG. 18 is an explanatory diagram illustrating an example of a resource for mapping a control channel and a data channel of each candidate beam;

FIG. 19 is an explanatory diagram illustrating an example of a table for managing a detection result of a control channel and a decoding result of a data channel for each candidate beam;

FIG. 20 is an explanatory diagram illustrating an example of a table for managing a detection result of a control channel, a decoding result of a data channel, and a reception state for each candidate beam;

FIG. 21 is a flowchart illustrating an example of a processing operation of a base station related to an update process;

FIG. 22 is an explanatory diagram illustrating an example of a time difference for each candidate beam;

FIG. 23 is an explanatory diagram illustrating an example of a correspondence relationship between a resource for mapping a control channel and a data channel and a response signal resource for mapping ACK/NACK;

FIG. 24 is a block diagram illustrating an example of a functional configuration of a transmission data processing unit, a transmission BB processing unit, and a wireless communication circuit related to a base station of the second embodiment;

FIG. 25 is an explanatory diagram illustrating an example of the resource for mapping a control channel and a data channel of each candidate beam related to the base station of the third embodiment;

FIG. 26 is an explanatory diagram illustrating an example of the resource for mapping a control channel and a data channel of each candidate beam related to the base station of the fourth embodiment;

FIG. 27 is an explanatory diagram illustrating an example of a table for managing the setting pattern for each candidate beam of the fifth embodiment;

FIG. 28 is an explanatory diagram illustrating an example of the resource for mapping a control channel and a data channel of each candidate beam related to the base station of the sixth embodiment;

FIG. 29 is an explanatory diagram illustrating an example of the resource for mapping a control channel and a data channel of each candidate beam related to the base station of the seventh embodiment;

FIG. 30 is an explanatory diagram illustrating an example of a table for managing a detection result of a control channel and a decoding result of a data channel for each candidate beam;

FIG. 31 is a block diagram illustrating an example of a hardware configuration of a base station; and

FIG. 32 is a block diagram illustrating an example of a hardware configuration of a terminal.

### DESCRIPTION OF EMBODIMENTS

Preferred embodiments of the present disclosure will be explained with reference to accompanying drawings. Note that the disclosed technology is not limited by the present embodiment. In addition, the following embodiments may be appropriately combined as long as there is no contradiction.

### (a) First Embodiment

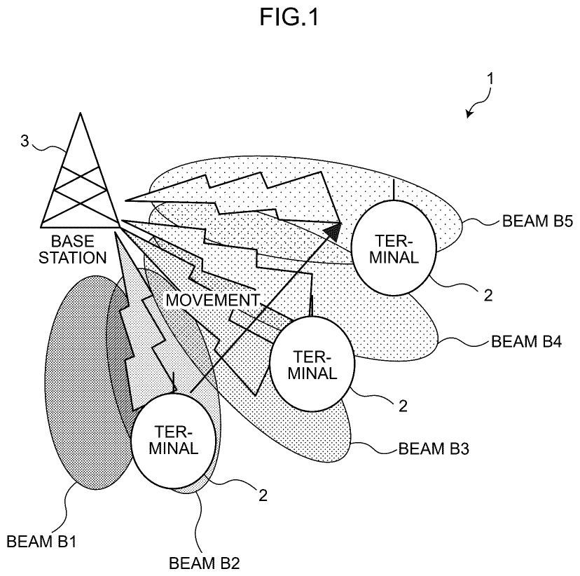

FIG. 1 is an explanatory diagram illustrating an example of a wireless communication system 1 of the present embodiment. The wireless communication system 1 illustrated in FIG. 1 is a wireless system capable of performing communication using, for example, a millimeter wave (for example, 5G millimeter wave) frequency band. The wireless communication system 1 includes a movable terminal 2 and a base station 3 that wirelessly communicates with the terminal 2.

In the wireless communication system 1 illustrated in FIG. 1, for example, it is assumed that the terminal 2 present in an area of a beam B2 moves in a direction of an arrow. The base station 3 transmits the control channel and the data channel addressed to the terminal 2 using, for example, the candidate beams B2, B3, B4, and B5 even if the base station 3 is not able to pinpoint in which beam area the terminal 2 is present. As a result, when the terminal 2 is in any area of the candidate beams B2, B3, B4, and B5, the terminal 2 can receive the control channel and the data channel addressed to the terminal 2 from the base station 3. Note that the control channel is, for example, a PDCCH. The data channel is, for example, a PDSCH.

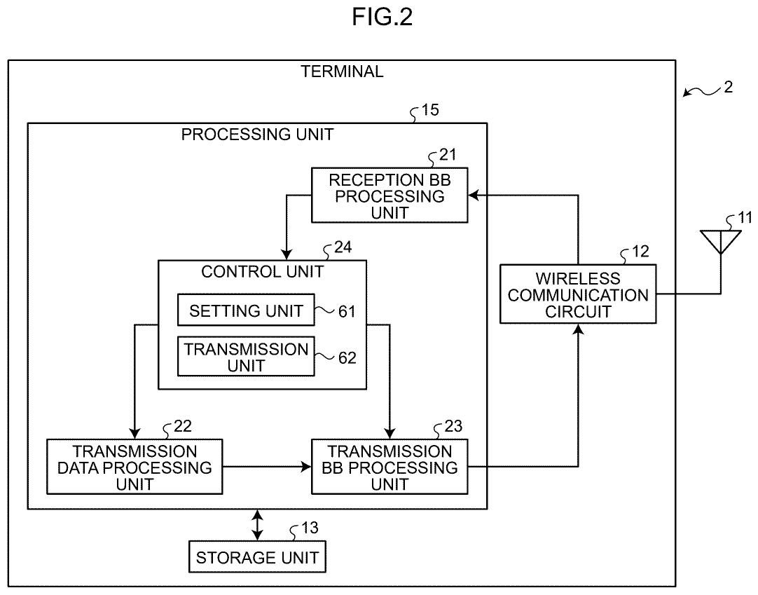

FIG. 2 is a block diagram illustrating an example of a functional configuration of the terminal 2. The terminal 2 illustrated in FIG. 2 includes an antenna element 11, a wireless communication circuit 12, a storage unit 13, and a processing unit 15. The antenna element 11 receives a wireless signal transmitted from the base station 3 to output the received wireless signal to the wireless communication circuit 12. The wireless communication circuit 12 performs processing such as down conversion (frequency conversion) or analog/digital (A/D) conversion on the wireless signal input from the antenna element 11 to convert the wireless signal into a base band (BB) signal. Then, the wireless communication circuit 12 outputs the converted BB signal to a reception BB processing unit 21 in the processing unit 15.

Furthermore, the BB signal is input from a transmission BB processing unit 23 in the processing unit 15, and the wireless communication circuit 12 performs various processes such as D/A conversion, up-conversion (frequency conversion), phase control, and amplification on the input BB signal to convert the BB signal into a wireless signal. Then, the wireless communication circuit 12 outputs the converted wireless signal to the antenna element 11. The antenna element 11 transmits the converted wireless signal input from the wireless communication circuit 12 to the base station 3.

The storage unit 13 temporarily stores various pieces of data when the processing unit 15 performs various processes on the BB signal. The processing unit 15 includes the reception BB processing unit 21, a transmission data processing unit 22, the transmission BB processing unit 23, and a control unit 24.

The reception BB processing unit 21 monitors the control channel from the base station 3 from the BB signal input from the wireless communication circuit 12, and executes various processes such as reception, demodulation, and decoding of data in the data channel based on the control channel. Thereafter, the reception BB processing unit 21 outputs the BB signal subjected to various types of processing to the control unit 24. The BB signal includes control information in a control channel from the base station 3 and user data in a data channel.

The control unit 24 controls the entire processing unit 15. The control unit 24 performs control related to error correction decoding such as Viterbi decoding or turbo decoding performed on the BB signal by the reception BB processing unit. Note that the decoding method corresponds to the encoding method executed on the transmission side. The control unit 24 performs, for example, processes such as acquisition control of information about candidate beams, control of CSI reporting, transmission control of ACK/NACK based on a detection result of a control channel and a decoding result of a data channel (derivation of transmission resources and timing, and indication of ACK/NACK type), and the like. The ACK/NACK is a delivery acknowledgement signal in which the terminal 2 reports the detection result of the control channel and the decoding result of the data channel to the base station 3 in the terminal 2.

The control unit 24 includes a setting unit 61 and a transmission unit 62 as functions. The setting unit 61 sets a plurality of beams that is candidates for the terminal 2 as candidate beams for data transmission/reception to be set by the base station 3. When receiving a data channel transmitted from the base station 3 using a plurality of beams which is candidate beams, the transmission unit 62 transmits a response signal to the base station 3 using an uplink control information resource corresponding to the received candidate beam of the data channel. Note that each of the plurality of beams as candidates for the terminal 2 is, for example, a beam corresponding to a position as a candidate of a movement destination of the terminal 2. Note that, for example, the plurality of beams includes a beam corresponding to the current position of the terminal 2.

The transmission data processing unit 22 executes various processes such as signal generation of ACK/NACK according to an instruction from the control unit 24, generation of a CSI report according to an instruction from the control unit 24, and generation of terminal information such as position information and a moving speed of the terminal 2 itself. Furthermore, the transmission data processing unit 22 executes various processes such as encoding of the transmission data to output the transmission data after execution to the transmission BB processing unit 23. The transmission BB processing unit 23 executes various processes such as modulation and mapping to physical resources on the encoded data from the transmission data processing unit 22 to output the BB signal after execution to the wireless communication circuit 12. The wireless communication circuit 12 converts the BB signal after execution into a wireless signal to output the wireless signal after conversion to the antenna element 11. The antenna element 11 transmits the converted wireless signal to the base station 3.

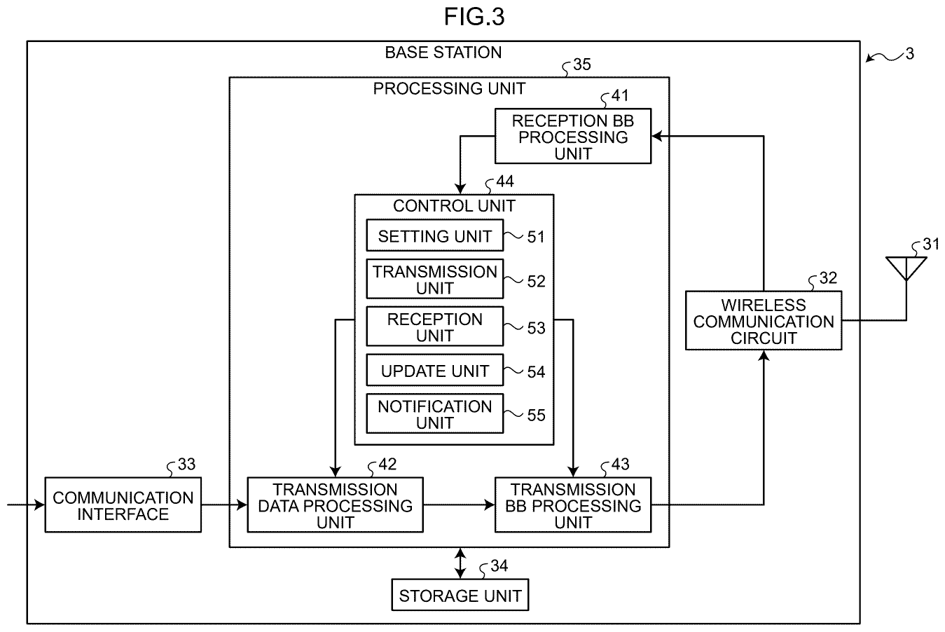

FIG. 3 is a block diagram illustrating an example of a functional configuration of the base station 3. The base station 3 illustrated in FIG. 3 includes an antenna element 31, a wireless communication circuit 32, a communication interface 33, a storage unit 34, and a processing unit 35. The antenna element 31 receives a wireless signal transmitted from the terminal 2 to output the received wireless signal to the wireless communication circuit 32. The wireless communication circuit 32 executes various processes such as down conversion (frequency conversion) and A/D conversion on the wireless signal input from the antenna element 31 to convert the wireless signal into a BB signal to output the BB signal after conversion to a reception BB processing unit 41 in the processing unit 35.

Furthermore, the wireless communication circuit 32 executes various processes such as D/A conversion, up-conversion (frequency conversion), and amplification on the BB signal input from a transmission BB processing unit 43 in the processing unit 35 to convert the BB signal into a wireless signal. Further, the wireless communication circuit 32 outputs the converted wireless signal to the antenna element 31. The antenna element 31 transmits the wireless signal input from the wireless communication circuit 32 to the terminal 2.

The storage unit 34 temporarily stores various pieces of data when the processing unit 35 performs various processes on the BB signal. The processing unit 35 includes the reception BB processing unit 41, a transmission data processing unit 42, the transmission BB processing unit 43, and a control unit 44. The reception BB processing unit 41 executes various processes such as channel estimation and channel compensation on the BB signal input from the wireless communication circuit 32.

The transmission data processing unit 42 executes various processes such as encoding and modulation of the transmission data to output the transmission data after execution to the transmission BB processing unit 43. The transmission BB processing unit 43 executes various processes such as mapping to physical resources on the modulated transmission data from the transmission data processing unit 42 to output the BB signal after execution to the wireless communication circuit 32. Furthermore, the transmission BB processing unit 43 executes a beamforming process of the modulated BB signal. The wireless communication circuit 32 converts the BB signal after execution into a wireless signal to output the wireless signal after conversion to the antenna element 31. The antenna element 31 transmits the converted wireless signal from the wireless communication circuit 32 to the terminal 2.

The control unit 44 controls the entire processing unit 35. The control unit 44 executes, for example, the setting process of candidate beams, the update process of candidate beams, the transmission process of transmitting with each beam, the determination process of a beam in which the terminal 2 is present, and the like. The control unit 44 includes a setting unit 51, a transmission unit 52, a reception unit 53, an update unit 54, and a notification unit 55 as functions.

The setting unit 51 sets a plurality of candidate beams for the terminal 2 as candidate beams for data transmission/reception. For example, the setting unit 51 determines the number of candidate beams and the position of the candidate beam corresponding to the candidate for the terminal 2 with reference to the candidate beam corresponding to the position of the terminal 2, and sets beams corresponding to the number of determined candidate beams as candidate beams. The transmission unit 52 transmits the control channel or the data channel having the same content using all the candidate beams. The reception unit 53 receives ACK/NACK, which is a response signal from the terminal 2 that has received the control channel or the data channel transmitted using any of the candidate beams. The update unit 54 executes the update process to be described later of updating a candidate beam for data transmission/reception based on ACK/NACK which is a response signal from the terminal 2. For example, the update unit 54 determines the number of candidate beams and the position of the candidate beam corresponding to the candidate for the terminal 2 with reference to the candidate beam for which the ACK has been detected, and sets beams corresponding to the number of determined candidate beams as candidate beams. As a result, the base station 3 can grasp the beam for which the terminal 2 actually is present based on the result of response of the terminal 2 and follow the latest position of the terminal 2 based on the grasped beam. The notification unit 55 notifies the terminal 2 of information about the set candidate beam.

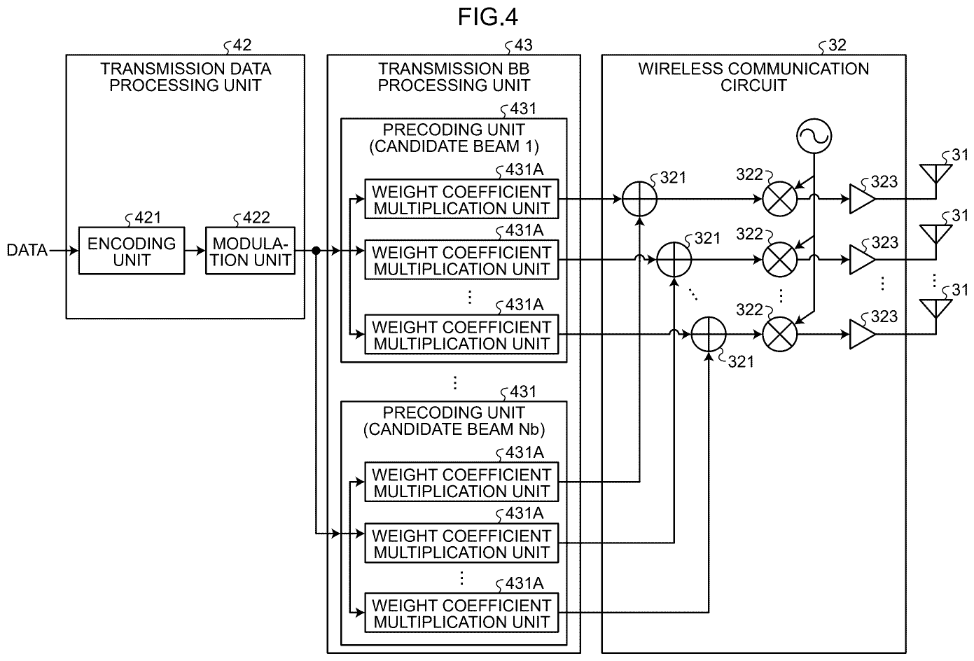

FIG. 4 is a block diagram illustrating an example of a functional configuration of the transmission data processing unit 42, the transmission BB processing unit 43, and the wireless communication circuit 32. The control unit 44 determines candidate beams by a setting process to be described later, and determines the modulation and coding scheme (MCS) of all the determined candidate beams. The transmission data processing unit 42 includes an encoding unit 421 and a modulation unit 422. The encoding unit 421 encodes the transmission data based on the encoding rate of the MCS. The modulation unit 422 modulates the encoded transmission data based on the modulation scheme of the MCS. In the embodiment, the MCS is common to all the determined candidate beams.

The transmission BB processing unit 43 includes a precoding unit 431 provided for each candidate beam to execute the precoding process on the modulated transmission data. The precoding unit 431 includes a plurality of weight coefficient multiplication units 431A provided for each antenna element 31 that executes the precoding process of multiplying the weight coefficient distributed to the antenna element 31 in order to form a beam of the BB signal after modulation from the transmission data processing unit 42. The precoding process is a beamforming process in which a wireless signal is weighted at an appropriate phase from each antenna element 31 and transmitted, and the power of the wireless signal is maximized on the terminal 2 side.

The wireless communication circuit 32 includes a plurality of multiplexing units 321, a plurality of up-converters 322, and a plurality of amplification units 323. The multiplexing unit 321 is provided for each antenna element 31, multiplexes the BB signal weighted by the weight coefficient multiplication unit 431A for each antenna element 31, and outputs the multiplexed BB signal to the up-converter 322 corresponding to the corresponding antenna element 31. The up-converter 322 is provided for each antenna element 31, generates a wireless signal by performing frequency conversion on the BB signal multiplexed by the multiplexing unit 321, and outputs the generated wireless signal to the amplification unit 323. The amplification unit 323 is provided for each antenna element 31, amplifies the wireless signal from the up-converter 322, and outputs the amplified wireless signal to the antenna element 31. Each antenna element 31 transmits the amplified wireless signal using each candidate beam. That is, each antenna element 31 transmits a wireless signal of the same content addressed to the terminal 2, that is, a control channel or a data channel addressed to the terminal 2, using each candidate beam determined by the control unit 44.

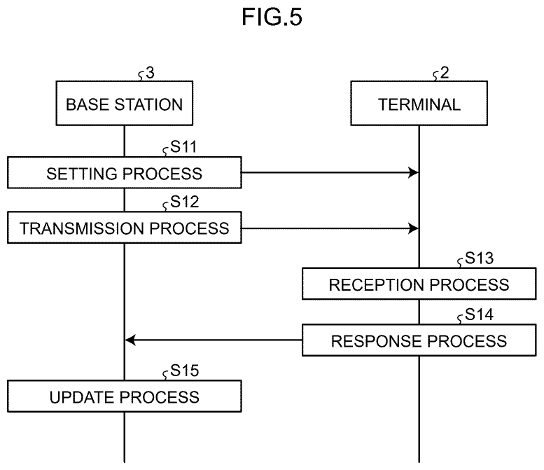

FIG. 5 is a sequence diagram illustrating an example of a processing operation related to a communication process of the wireless communication system 1. In FIG. 5, the base station 3 executes a setting process of setting a candidate beam as a measurement report target in the terminal 2 (step S11). Note that the terminal 2 can recognize the candidate beam set by the base station 3.

Further, after executing the setting process, the base station 3 executes the transmission process of transmitting the control channel or the data channel addressed to the terminal 2 using the set candidate beam (step S12). The base station 3 transmits the control channel or the data channel of the same content addressed to the terminal 2 by applying the same MCS using all the set candidate beams. As a result, the terminal 2 can receive the control channel and the data channel without being aware of which candidate beam the control channel and the data channel are transmitted with.

The terminal 2 executes a reception process of detecting the control channel addressed to the terminal 2 transmitted using the candidate beam of the area which is actually present among the set candidate beams (step S13).

After executing the reception process, the terminal 2 executes a response process of transmitting ACK/NACK, which is a response corresponding to result of the reception process, to the base station 3 (step S14). When the data channel is successfully decoded based on the detected control channel, the terminal 2 transmits the ACK to the base station 3 using the response signal resource corresponding to the candidate beam that has received the data channel, and when the data channel is not successfully decoded, the terminal 2 transmits the NACK to the base station 3.

The base station 3 executes the update process of updating the candidate beam based on the response from the terminal 2 (step S15). That is, the base station 3 can recognize that the terminal 2 is actually located in the area of the candidate beam based on the response signal resource that has received the ACK that is the response from the terminal 2. Then, the base station 3 updates the candidate beams corresponding to the number of new candidate beams based on the candidate beams of the area in which the terminal 2 is actually located, and the process proceeds to the setting process of step S11.

When the base station covers the communication area by temporally changing the direction of the beam of the transmission signal, it is conceivable to transmit the data signal in the time zone corresponding to the candidate beam. In a case where there is a time constraint on the candidate beam for transmitting the data signal and the base station 3 transmits the data signal accordingly, when the base station 3 explicitly notifies the terminal 2 of the candidate beam, the degree of freedom of the time for transmitting the data increases in the time zone allocated to the candidate beam.

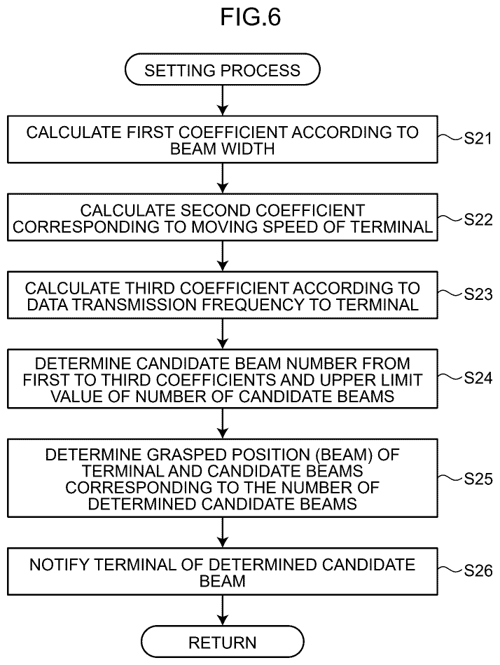

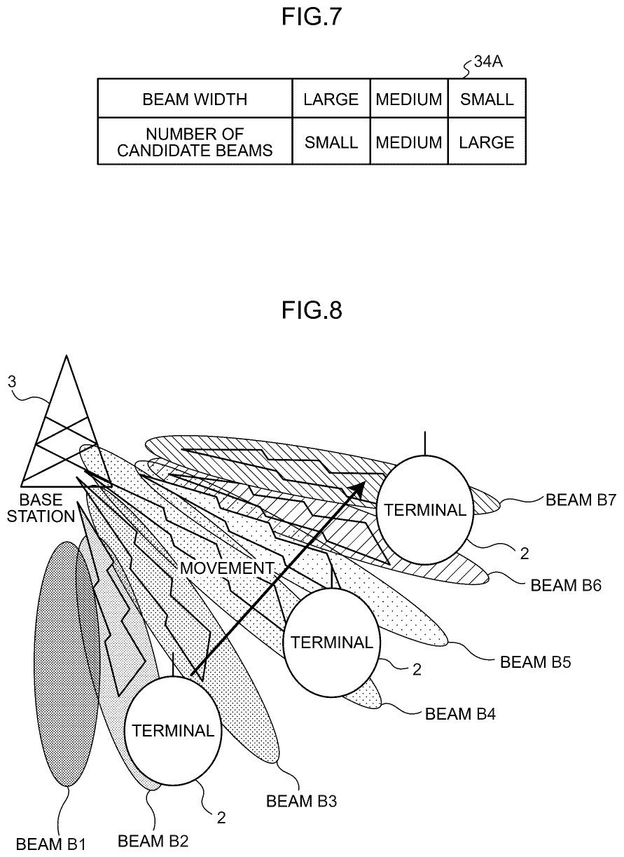

FIG. 6 is a flowchart illustrating an example of a processing operation of the base station 3 related to a setting process. In FIG. 6, the setting unit 51 in the control unit 44 of the base station 3 calculates a first coefficient according to the beam width (step S21). Note that the first coefficient is the number of candidate beams corresponding to the beam width in a table 34A illustrated in FIG. 7.

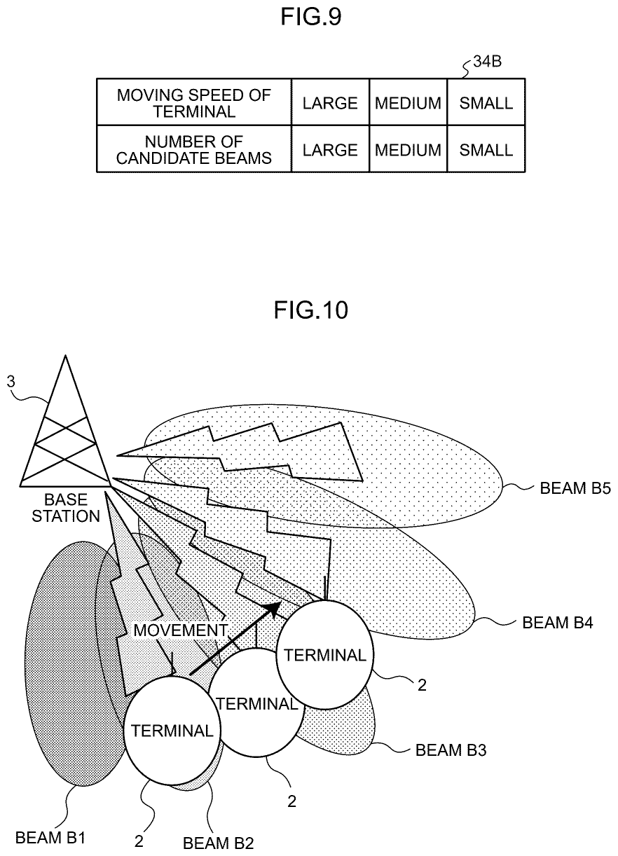

The setting unit 51 calculates a second coefficient corresponding to the moving speed of the terminal 2 (step S22). Note that the second coefficient is the number of candidate beams corresponding to the moving speed in a table 34B illustrated in FIG. 9.

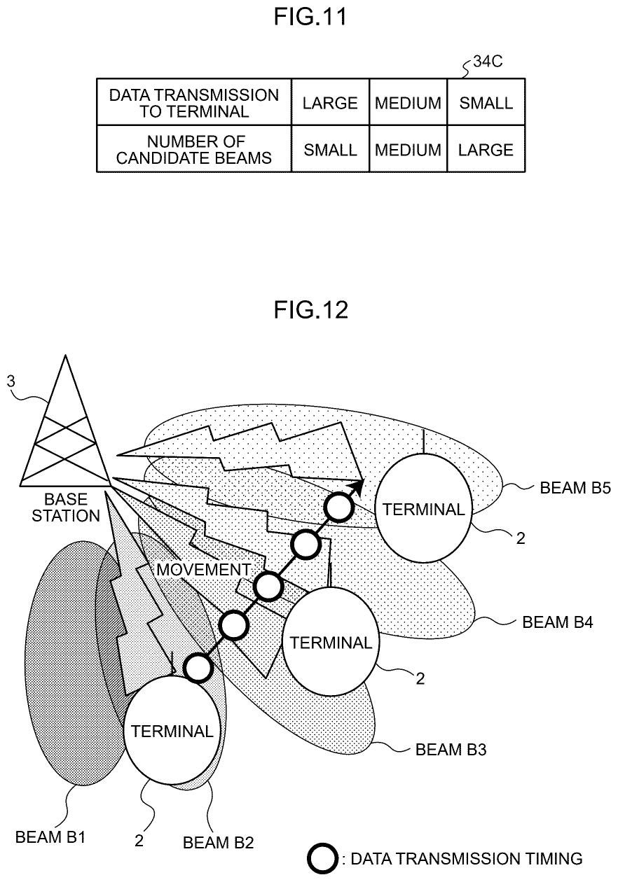

The setting unit 51 calculates a third coefficient according to how frequently the data transmission to the terminal 2 occurs (step S23). Note that the third coefficient is the number of candidate beams according to how frequently the data transmission to the terminal occurs in a table 34C illustrated in FIG. 11. Although a numerical value is not specifically set for the third coefficient, which is the number of candidate beams illustrated in FIG. 11, for convenience of description, the third coefficient is a coefficient corresponding to the ranks of three levels of large, medium, and small.

The setting unit 51 determines the number of candidate beams to be allocated to the terminal 2 based on the first coefficient, the second coefficient, the third coefficient, and the upper limit value of the number of candidate beams (step S24). Note that the upper limit value of the number of candidate beams is the upper limit number of beams that can be set for a single terminal 2 by the base station 3. Note that the upper limit number of beams that can be set may be described as a predetermined number of candidate beams. The number of candidate beams to be allocated to the terminal 2 may be a number corresponding to the upper limit value of the number of candidate beams, or may be a number equal to or less than the upper limit value of the number of candidate beams.

Furthermore, the setting unit 51 determines candidate beams corresponding to the number of candidate beams based on the grasped position of the terminal 2 and the number of candidate beams determined in step S24 (step S25). Then, the setting unit 51 notifies the terminal 2 of candidate beams corresponding to the number of candidate beams determined in step S25 (step S26), and ends the processing operation illustrated in FIG. 6.

FIG. 7 is an explanatory diagram illustrating an example of a table 34A for setting the number of candidate beams according to the beam width. The table 34A illustrated in FIG. 7 is a table for managing the first coefficient that is the number of candidate beams according to the beam width, and is stored in the storage unit 34. The beam width is divided into three levels of large, medium, and small. In a case where the beam width is wider than the medium beam width, the beam width is large, and in a case where the beam width is narrower than the medium beam width, the beam width is small. The number of candidate beams is divided into three levels of large, medium, and small. In a case where the number of candidate beams is larger than the medium number of candidate beams, the number is large, and in a case where the number of candidate beams is smaller than the medium number of candidate beams, the number is small. The table 34A illustrated in FIG. 7 stores the number of candidate beams according to the beam width. The table 34A stores candidate beams such that the number of candidate beams is small according to the small beam width, the number of candidate beams is medium according to the medium beam width, and the number of candidate beams is large according to the large beam width. Note that, for convenience of description, although a numerical value is not specifically set, the first coefficient that is the number of candidate beams is a coefficient corresponding to the ranks of three levels of large, medium, and small. For example, when the beam width is large, the beam width is equal to or larger than the first width, when the beam width is medium, the beam width is less than the first width and equal to or larger than the second width, and when the beam width is small, the beam width is less than the second width. Further, for example, when the beam width is large, the beam width exceeds the first width, when the beam width is medium, the beam width is equal to or less than the first width and exceeds the second width, and when the beam width is small, the beam width is equal to or less than the second width. The first width is larger than the second width.

FIG. 8 is an explanatory diagram illustrating an example of setting the number of candidate beams according to the beam width. When the beam width is narrow and small, the control unit 44 in the base station 3 refers to the table 34A, reads a large number of candidate beams, and sets, for example, seven candidate beams of the beams B1 to B7 for the terminal 2. Note that, for convenience of description, the case where the control unit 44 refers to the table 34A and reads the number of candidate beams according to the beam width has been exemplified, but the number of candidate beams may be calculated according to the beam width and can be appropriately changed.

FIG. 9 is an explanatory diagram illustrating an example of the table 34B for setting the number of candidate beams according to the moving speed of the terminal 2. The table 34B illustrated in FIG. 9 is a table for managing the second coefficient that is the number of candidate beams in accordance with the moving speed of the terminal 2 and is stored in the storage unit 34. The moving speed of the terminal 2 is divided into three levels of large, medium, and small. In a case where the moving speed is faster than a medium moving speed, the speed is large, and in a case where the moving speed is slower than the medium moving speed, the speed is small. The number of candidate beams is divided into three levels of large, medium, and small. The table 34B stores candidate beams such that the number of candidate beams is large according to a large moving speed, the number of candidate beams is medium according to a medium moving speed, and the number of candidate beams is small according to a small moving speed. Note that, a method of detecting the moving speed of the terminal 2, for example, includes a method of estimating the moving speed of the terminal 2 from a data transmission/reception history, a method of causing the terminal 2 to report position information and estimating the moving speed of the terminal 2 from the history, a method of causing the terminal 2 to report the moving speed, and the like. Note that, for convenience of description, although a numerical value is not specifically set the second coefficient that is the number of candidate beams is a coefficient corresponding to the ranks of three levels of large, medium, and small. For example, when the moving speed is large, the moving speed is equal to or more than the first speed, when the moving speed is medium, the moving speed is less than the first speed and equal to or more than the second speed, and when the moving speed is small, the moving speed is less than the second speed. Further, for example, when the moving speed is large, the moving speed exceeds the first speed, when the moving speed is medium, the moving speed is equal to or less than the first speed and exceeds the second speed, and when the moving speed is small, the moving speed is equal to or less than the second speed. Note that the first speed is a value larger than the second speed.

FIG. 10 is an explanatory diagram illustrating an example of setting the number of candidate beams according to the moving speed of the terminal 2. When the moving speed is slow and small, the control unit 44 refers to the table 34B, reads the small number of candidate beams, for example, three candidate beams of the beams B1 to B3, and sets the candidate beams corresponding to the read number of candidate beams to the terminal 2. Note that, for convenience of description, the case where the control unit 44 refers to the table 34B and reads the number of candidate beams according to the moving speed of the terminal 2 has been exemplified, but the number of candidate beams may be calculated according to the moving speed and can be appropriately changed.

FIG. 11 is an explanatory diagram illustrating an example of a table 34C for setting the number of candidate beams according to how frequently the data transmission to the terminal 2 occurs. A table 34C illustrated in FIG. 11 is a table for managing the third coefficient, which is the number of candidate beams, according to how frequently the data transmission to the terminal 2 occurs, and is stored in the storage unit 34. How frequently the data transmission to the terminal 2 occurs is divided into three levels of large, medium, and small. In a case where how frequently the data transmission occurs is higher than the medium level, how frequently the data transmission occurs is large, and in a case where how frequently the data transmission occurs is lower than the medium level, how frequently the data transmission occurs is small. The number of candidate beams is divided into three levels of large, medium, and small. The table 34C stores candidate beams such that the number of candidate beams is small if how frequently the data transmission occurs is large, the number of candidate beams is medium if how frequently the data transmission occurs is medium, and the number of candidate beams is large if how frequently the data transmission occurs is small. In a case where how frequently the data transmission occurs is large, when the distance that the terminal 2 moves within the interval of transmitting data is short, and the opportunity to update the number of candidate beams increases, so that the number of candidate beams is reduced. In a case where how frequently the data transmission occurs is small, when the distance that the terminal 2 moves within the interval of transmitting data is long, and the opportunity to update the number of candidate beams decreases, so that the number of candidate beams is increased. For convenience of description, the third coefficient, which is the number of candidate beams, is a coefficient corresponding to the ranks of three levels including large, medium, and small, although a numerical value is not specifically set. Note that, for example, when how frequently the data transmission occurs is large, how frequently the data transmission occurs is equal to or more than the first number, when how frequently the data transmission occurs is medium, how frequently the data transmission occurs is less than the first number and equal to or more than the second number, and when how frequently the data transmission occurs is small, how frequently the data transmission occurs is less than the second number. Further, for example, when how frequently the data transmission occurs is large, how frequently the data transmission occurs exceeds the first number, when how frequently the data transmission occurs is medium, how frequently the data transmission occurs is equal to or less than the first number and exceeds the second number, and when how frequently the data transmission occurs is small, how frequently the data transmission occurs is equal to or less than the second number. Note that the first number is a value larger than the second number.

FIG. 12 is an explanatory diagram illustrating an example of setting the number of candidate beams according to how frequently the data transmission to the terminal 2 occurs. When how frequently the data transmission occurs is many and large, the control unit 44 refers to the table 34C, reads the small number of candidate beams, for example, three candidate beams of the beams B1 to B3, and sets the candidate beams corresponding to the read number of candidate beams in the terminal 2. Note that, for convenience of description, a case where the control unit 44 refers to the table 34C and reads the number of candidate beams according to how frequently the data transmission to the terminal 2 occurs has been exemplified. However, the number of candidate beams may be calculated according to how frequently the data transmission occurs, and can be appropriately changed.

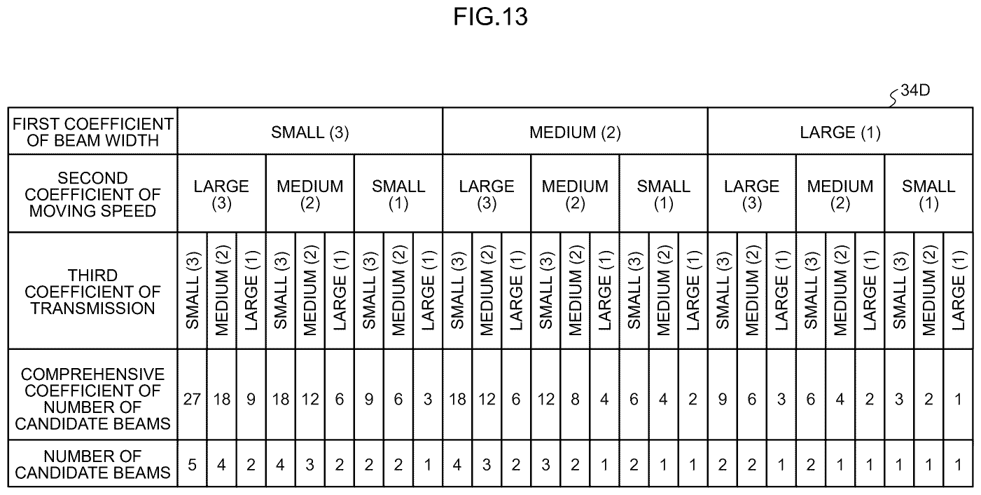

In addition, the case where the control unit 44 in the base station 3 determines the number of candidate beams for the terminal 2 according to the beam width, the moving speed of the terminal 2, and how frequently the data transmission to the terminal 2 occurs has been exemplified. However, the control unit 44 in the base station 3 may determine the number of candidate beams that is the comprehensive coefficient in accordance with the relationship between the beam width, the moving speed of the terminal 2, and how frequently the data transmission for the terminal 2 occurs. FIG. 13 is an explanatory diagram illustrating an example of a table 34D for setting the number of candidate beams according to the comprehensive coefficient. A table 34D illustrated in FIG. 13 is a table for managing the comprehensive coefficient that is the number of candidate beams and is stored in the storage unit 34. For example, the control unit 44 associates 1 to 3 coefficients with each of the beam width, the moving speed of the terminal 2, and how frequently the data transmission to the terminal 2 occurs, for example, associates 3 with large, 2 with medium, and 1 with small, and calculates the coefficient of the candidate beam number according to the combination. The control unit 44 sets, as the number of candidate beams, a result (rounding up after the decimal point) of multiplying a value obtained by dividing the calculated coefficient of the candidate beam number by 27 by the upper limit value of the number of candidate beams. The case where the control unit 44 sets, as the coefficient of the number of candidate beams, a value obtained by multiplying the coefficients (1 to 3) for large, medium, and small for each factor, and sets the upper limit value of the candidate beams to 5 has been exemplified. The control unit 44 determines the number of candidate beams that is a comprehensive coefficient using <first coefficient corresponding to beam width×second coefficient corresponding to moving speed×third coefficient corresponding to how frequently data transmission occurs/normalization coefficient×upper limit value of the number of candidate beams (rounded up to integer value)>. Then, the number of candidate beams determined according to the relationship between the beam width, the moving speed of the terminal 2, and how frequently the data transmission with respect to the terminal 2 occurs is stored in the table 34D. Then, the control unit 44 refers to the table 34D and determines the number of candidate beams for the terminal 2.

Note that, in the control unit 44 of the present embodiment, the number of candidate beams is determined according to the beam width, the moving speed of the terminal 2, and how frequently the data transmission occurs, but the number of candidate beams may be determined in consideration of the distance between the base station 3 and the terminal 2 or the moving direction of the terminal 2, and can be appropriately changed.

In addition, the number of levels of the number of candidate beams, the upper limit of the number of candidate beams, and the like according to the beam width, the moving speed of the terminal 2 and how frequently the data transmission occurs are an examples, and may be values other than the values illustrated in the present embodiment.

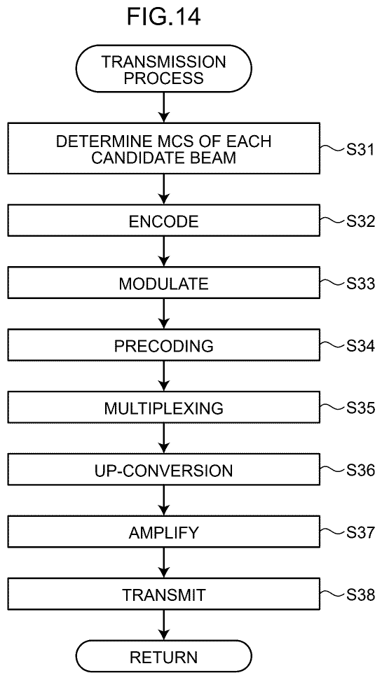

FIG. 14 is a flowchart illustrating an example of a processing operation of the base station 3 related to a transmission process. In FIG. 14, the transmission unit 52 in the control unit 44 in the base station 3 determines the MCS of the candidate beam addressed to the terminal 2 determined in the setting process (step S31). The transmission unit 52 sets the encoding rate in the determined MCS in the encoding unit 421 (step S32). The transmission unit 52 sets the modulation scheme in the determined MCS to the modulation unit 422 (step S33). That is, the encoding unit 421 encodes the transmission data based on the set encoding rate to output the encoded transmission data to the modulation unit 422. The modulation unit 422 modulates the encoded transmission data based on the set modulation scheme to output the BB signal to the precoding unit 431 of each determined candidate beam.

The candidate beam precoding unit 431 multiplies the modulated BB signal by a weighting coefficient to output the multiplied BB signal to the multiplexing unit 321 of each antenna element that generates a candidate beam (step S34). The multiplexing unit 321 of each antenna element multiplexes the multiplied BB signals distributed by the precoding unit 431 of the candidate beams to output the multiplexed BB signals to the up-converter 322 corresponding to each antenna element (step S35).

The up-converter 322 of each antenna element performs frequency conversion on the multiplexed BB signal to output a wireless signal to the amplification unit 323 corresponding to each antenna element (step S36). The amplification unit 323 of each antenna element amplifies the wireless signal corresponding to each antenna element to output the amplified wireless signal to the antenna element 31 (step S37). Then, each antenna element 31 that generates the candidate beam transmits and outputs the amplified wireless signal (step S38), and ends the transmission process illustrated in FIG. 14.

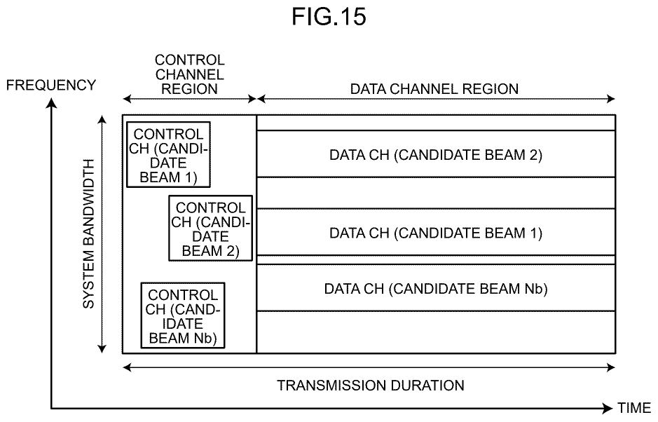

FIG. 15 is an explanatory diagram illustrating an example of the resource for mapping a control channel and a data channel of each candidate beam. The resource illustrated in FIG. 15 has a control channel region for mapping a control channel of each candidate beam and a data channel region for mapping a data channel of each candidate beam in a resource in the same transmission duration and the system bandwidth. The control CH is a control channel, and the data CH is a data channel. The transmission duration may be, for example, a concept of a time having an any length such as a frame, a subframe, a slot, a symbol, or a plurality of these connected as a unit. In addition, a data channel and a control channel are mapped in the duration. For example, in a 5G system or a 4G system, the duration may be referred to as a transmission duration or a transmission time interval (TTI). The base station 3 transmits the control channel and the data channel of each candidate beam in the same system bandwidth and the same transmission duration.

The terminal 2 attempts to detect the control channel in a common search space (region for monitoring the control channel) between the candidate beams. Alternatively, the search space may be different for each candidate beam. However, in this case, it is important to notify the terminal 2 of which candidate beam is set. Since each control channel and each data channel are transmitted to be intensified in different directions (beam areas) by applying different beamforming, a receivable control channel and data channel also change according to a position where the terminal 2 is present. The terminal 2 can receive only the control channel and the data channel of the candidate beam reaching the position where the terminal 2 is present.

In Rel-17 of the 5G standard specification, in order to maintain synchronization and report measurement of beams, the base station sets SSB/CSI for the terminal. On the other hand, the demodulation RS sequence for receiving the data channel and the control channel associated therewith does not depend on beamforming (precoding) applied to the control channel and the data channel. Therefore, the terminal can receive the control channel and the data channel addressed to the terminal without being aware of which beam the base station transmits with.

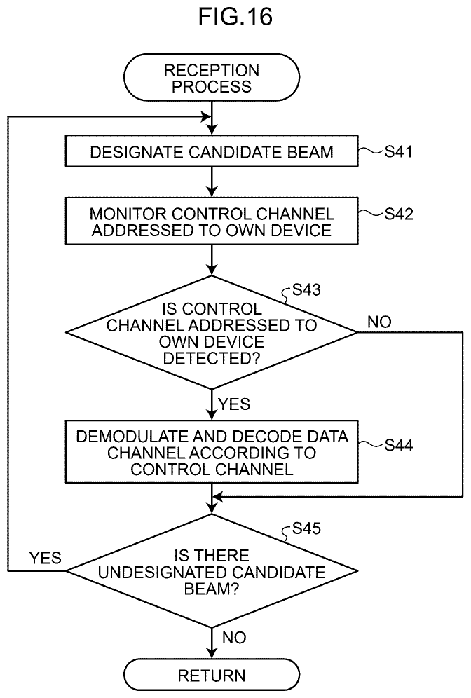

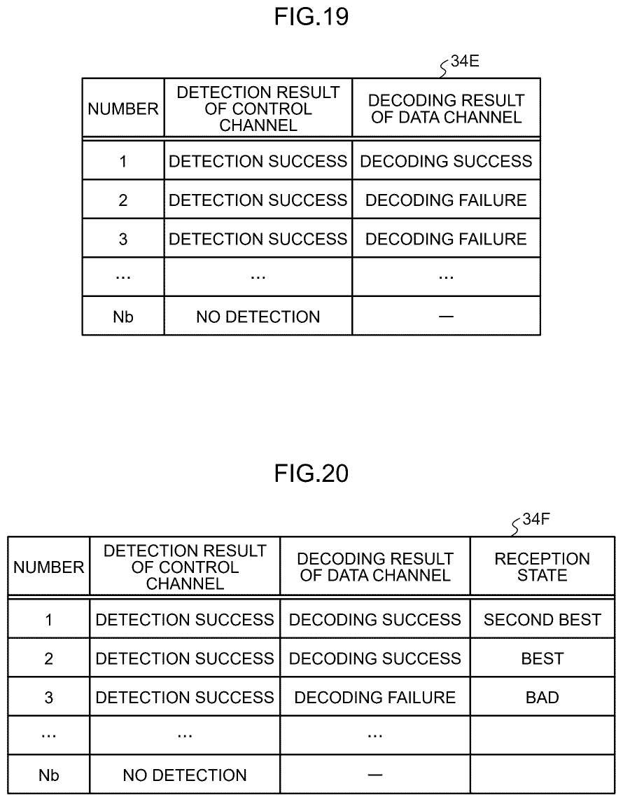

FIG. 16 is a flowchart illustrating an example of the processing operation of the terminal 2 related to a reception process. In FIG. 16, the setting unit 61 in the control unit 24 in the terminal 2 designates an undesignated candidate beam for which control channel monitoring (which may be referred to as search) has not yet been performed among the plurality of candidate beams set in the base station 3 (step S41). The setting unit 61 monitors the control channel of the designated candidate beam addressed to the own device as the terminal 2 (step S42). When the search space is different for each candidate beam, the control channel is monitored with respect to the search space corresponding to the candidate beam to be searched. The setting unit 61 determines whether a control channel addressed to the own device has been detected (step S43). When detecting the control channel addressed to the own device (step S43: Yes), the setting unit 61 demodulates and decodes the data channel of the candidate beam addressed to the own device based on the detected control channel addressed to the own device (step S44). The setting unit 61 stores the detection result (detection success) of the control channel and the decoding result (decoding success or decoding failure) of the data channel for each number identifying the candidate beam in a table 34E illustrated in FIG. 19 to be described later.

After demodulating and decoding the data channel of the designated candidate beam addressed to the own device, the setting unit 61 determines whether there is an undesignated candidate beam (step S45). When there is an undesignated candidate beam (step S45: Yes), the setting unit 61 advances the process to the process of step S41 to designate an undesignated candidate beam.

When there is no undesignated candidate beam (step S45: No), the setting unit 61 ends the processing operation illustrated in FIG. 16. In a case where the setting unit 61 has not detected the control channel addressed to the own device (step S43: No), the process proceeds to step S45 in order to determine whether there is an undesignated candidate beam. The setting unit 61 stores the detection result (no detection) of the control channel and the decoding result of the data channel for each number for identifying the candidate beam in the table 34E illustrated in FIG. 19 to be described later.

When the candidate beam and the number of candidate beams are notified from the base station 3 to the terminal 2, a process of determining whether the control channel addressed to the own device is detected until there is no undesignated candidate beam is executed. However, in a case where the candidate beam and the number of candidate beams are not notified from the base station 3 to the terminal 2 or in a case of setting to search for a common search space among the candidate beams, the entire search space for detecting the control channel is searched. As a result, the process of determining whether the control channel addressed to the own device is detected is executed for all the candidate beams.

In addition, in the reception process, the monitoring of the control channel addressed to the own device is sequentially executed for each designated candidate beam, but the monitoring of the control channel addressed to the own device may be collectively executed in parallel for a plurality of candidate beams, and can be appropriately changed.

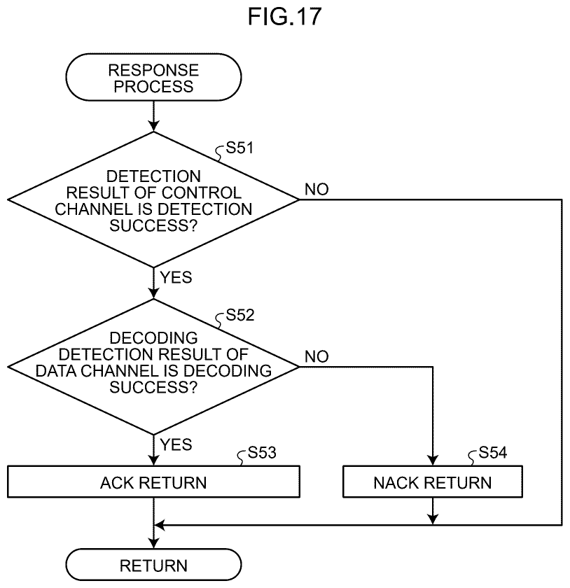

FIG. 17 is a flowchart illustrating an example of the processing operation of the terminal 2 related to the response process. In FIG. 17, the transmission unit 62 in the control unit 24 of the terminal 2 executes the response process for each candidate beam. The transmission unit 62 refers to the table 34E illustrated in FIG. 19 and determines whether the detection result of the control channel addressed to the own device is the detection success (step S51). When the detection result of the control channel addressed to the own device is the detection success (step S51: Yes), the transmission unit 62 determines whether the decoding result of the data channel addressed to the own device is the decoding success (step S52).

When the decoding result of any of the data channels is the decoding success (step S52: Yes), the transmission unit 62 returns the ACK to the base station 3 using the response signal resource corresponding to the candidate beam for which decoding has succeeded (step S53), and ends the response process illustrated in FIG. 17. Note that the terminal 2 may return the ACK to the base station 3 using the uplink control channel or by multiplexing the ACK into data of the uplink data channel, and can change the channel used to return the ACK as appropriate.

When the decoding result of any of the data channels is not the decoding success (step S52: No), the transmission unit 62 determines that the decoding has failed, returns NACK to the base station 3 using the response signal resource corresponding to any of the candidate beams for which the decoding has not been successful (step S54), and ends the processing operation illustrated in FIG. 17. Note that the terminal 2 may return the NACK to the base station 3 using the uplink control channel or by multiplexing the NACK into data of the uplink data channel, and can change the channel used to return the NACK as appropriate. In addition, in a case where the detection results of all the control channels are not the detection success (step S51: No), the transmission unit 62 ends the processing operation illustrated in FIG. 17.

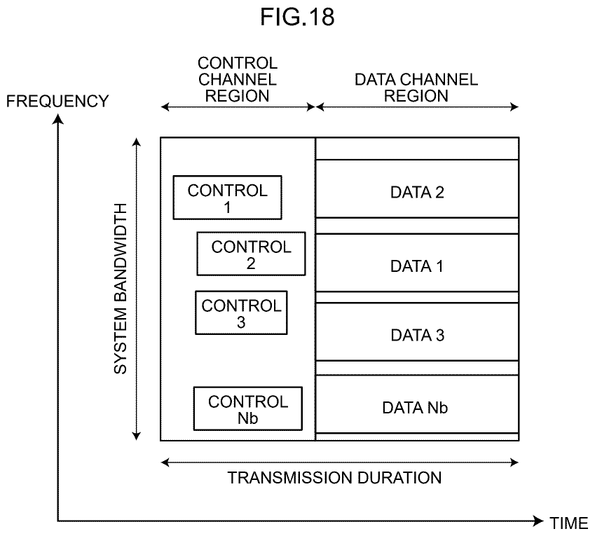

Next, a method of returning a response corresponding to result (ACK/NACK) to the base station 3 using a resource for a response signal corresponding to a control channel of successful detection when the terminal 2 has successfully detected a control channel for a plurality of candidate beams will be described. FIG. 18 is an explanatory diagram illustrating an example of the resource for mapping a control channel and a data channel of each candidate beam. It is assumed that the control channel and the data channel of each candidate beam are transmitted in the same transmission duration between the candidate beams. Note that, for example, the control channel of the candidate beam B1 is control 1, the control channel of the candidate beam B2 is control 2, and the control channel of the candidate beam B3 is control 3. For example, the data channel of the candidate beam B1 is data 1, the data channel of the candidate beam B2 is data 2, and the data channel of the candidate beam B3 is data 3.

FIG. 19 is an explanatory diagram illustrating an example of the table 34E for managing the detection result of the control channel and the decoding result of the data channel for each candidate beam. Since the base station 3 transmits the control channels of each candidate beam in the same transmission duration, the terminal 2 receives the control channels at the same position in the same transmission duration. The control unit 24 in the terminal 2 stores the detection result of the control channel and the decoding result of the data channel for each number for identifying the candidate beam in the table 34E. The detection result of the control channel includes detection success and no detection, and the decoding result of the data channel includes decoding success and decoding failure. The terminal 2 identifies the detection result of the control channel and the decoding result of the data channel of each candidate beam with reference to the table 34E. In the example of FIG. 19, for example, the detection result of the control channel of the candidate beam B1 is detection success, the decoding result of the data channel of the candidate beam BI is decoding success, the detection result of the control channel of the candidate beam B2 is detection success, the decoding result of the data channel of the candidate beam B2 is decoding failure, and the like.

The control unit 24 in the terminal 2 determines that the pair of the control channel of successful detection and the data channel of successful decoding is optimal among the plurality of candidate beams, and returns the ACK in the resource for the response signal corresponding to the control channel associated with the data channel of successful decoding. The terminal 2 refers to the table 34E illustrated in FIG. 19, determines that the candidate beam B1 is optimal, and returns the ACK to the base station 3 using the response signal resource corresponding to the control channel of the control 1 of the candidate beam B1 illustrated in FIG. 18.

The case where the terminal 2 manages the detection result of the control channel and the decoding result of the data channel for each number for identifying the candidate beam as the table 34E for managing the response for each candidate beam has been exemplified, but the present disclosure is not limited thereto, and a table 34F illustrated in FIG. 20 may be used. FIG. 20 is an explanatory diagram illustrating an example of the table 34F for managing a detection result of a control channel, a decoding result of a data channel, and a reception state for each candidate beam. The control unit 24 in the terminal 2 stores the detection result of the control channel, the decoding result of the data channel, and the reception state for each number for identifying the candidate beam in the table 34F. The control unit 24 in the terminal 2 measures the SN ratio (signal-to-noise power ratio) of the RS of each candidate beam, classifies the measurement result, and stores the result in the table 34F as the reception state. The classification of the reception state is best, second best, bad, or the like.

The control unit 24 refers to the table 34F and determines that the combination of the control channel of successful detection, the data channel of successful decoding, and the best reception state among the plurality of candidate beams is optimal. Then, the terminal 2 returns the ACK with the resource for the response signal corresponding to the control channel associated with the data channel of successful decoding. The control unit 24 refers to the table 34F illustrated in FIG. 20 and determines that the candidate beam B2 is optimal. Then, the terminal 2 returns the ACK to the base station 3 using the response signal resource corresponding to the control channel of the control 2 of the candidate beam B2 illustrated in FIG. 18.

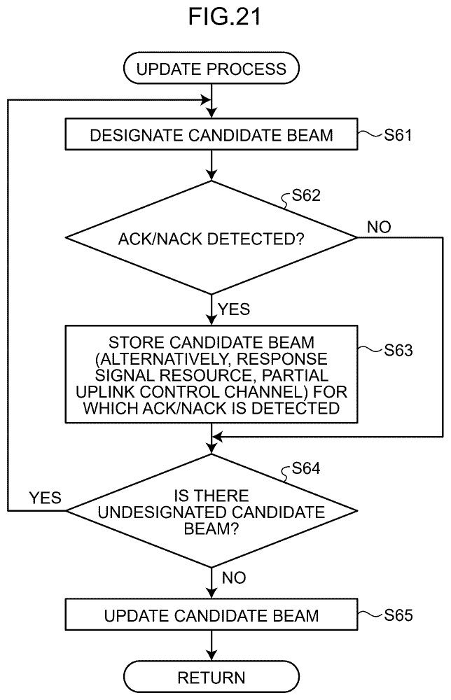

FIG. 21 is a flowchart illustrating an example of a processing operation of the base station 3 related to the update process. In FIG. 21, the update unit 54 in the control unit 44 of the base station 3 designates one undesignated candidate beam among the undesignated candidate beams (step S61). After designating an undesignated candidate beam, the update unit 54 determines whether ACK/NACK for the signal of the designated candidate beam has been detected (step S62).

When the ACK/NACK for the signal of the designated candidate beam is detected (step S62: Yes), the update unit 54 stores the candidate beam (or the response signal resource) for which the ACK/NACK is detected (step S63). Note that even in a case where a plurality of beams is transmitted in a common control channel region or data channel region, the beams can be distinguished by a time notified in control information contained in a control channel or a parameter (for example, in the case of the 5G system, a parameter (PDSCH-to-HARQ feedback timing or ΔPRI (PUCCH resource indicator)) notified in downlink control information (DCI)) indicating a control channel resource.

After storing the candidate beam for which the ACK/NACK is detected, the update unit 54 determines whether there is an undesignated candidate beam (step S64). When there is no undesignated candidate beam (step S64: No), the update unit 54 updates the latest candidate beam addressed to the terminal 2 based on the candidate beam for which the ACK has been detected (step S65), and ends the processing operation illustrated in FIG. 21. That is, the update unit 54 determines the number of candidate beams and the position of the candidate beam according to the comprehensive coefficient illustrated in FIG. 13 with the candidate beam for which the ACK has been detected as a reference, and updates the number of candidate beams and the position of the candidate beam as the number of determined candidate beams.

In addition, when there is an undesignated candidate beam (step S64: Yes), the update unit 54 advances the process to the process of step S61 to designate the undesignated candidate beam. In addition, in a case where the ACK/NACK for the signal of the designated candidate beam has not been detected (step S62: No), the update unit 54 advances the process to the process of step S64 of determining whether there is an undesignated candidate beam.

Note that, for convenience of description, in the update process, the ACK/NACK detection determination process is individually executed for each designated candidate beam, but the ACK/NACK detection determination process may be collectively executed in parallel for a plurality of candidate beams, and can be appropriately changed.

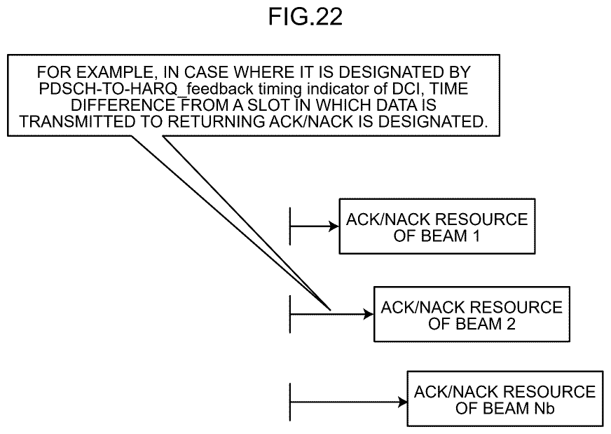

FIG. 22 is an explanatory diagram illustrating an example of a time difference for each candidate beam. For example, when designated by the PDSCH-to-HARQ feedback timing indicator of the DCI in the 5G system, a time difference from a slot in which data is transmitted to returning ACK/NACK is designated. In addition, it can be designated with the RRC setting, but the description in this case is omitted.

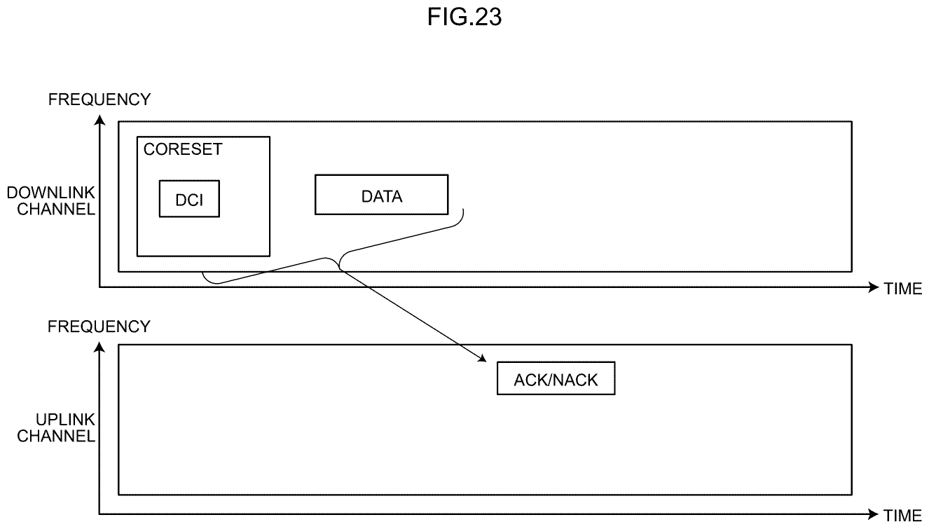

A control channel is present in a signal transmitted by the base station 3 in each candidate beam. A resource (response signal resource) in which the terminal 2 returns the ACK/NACK differs depending on the mapping location of the control channel. FIG. 23 is an explanatory diagram illustrating an example of a correspondence relationship between a resource for storing a control channel and a data channel and a response signal resource for storing ACK/NACK. The base station 3 grasps a control channel through which the terminal 2 can actually receive data based on which response signal resource the ACK/NACK is returned with (determination of presence/absence of ACK/NACK), and grasps a candidate beam in which the terminal 2 actually is present from the grasped control channel. Then, the latest candidate beam is updated based on the grasped candidate beam. In the current 5G system, it is possible to designate the feedback timing of the HARQ by the DCI or the RRC signal (see section 5.2.5.4 of TS 38.300 V17.2.0 (September 2022)). The resource for storing the control channel and the data channel may be referred to as a resource for mapping the control channel and the data channel or a resource for transmitting the control channel and the data channel. In addition, the response signal resource for storing the ACK/NACK may be referred to as a resource for mapping the response signal or a resource for transmitting the response signal.

For example, in a case where the present disclosure is applied to the 5G system, the base station 3 provides (instructs) the terminal 2 with the feedback timing of the HARQ-ACK dynamically using the DCI or semi-statically using the RRC setting. When designated by the DCI, there is a field called a PDSCH-to-HARQ feedback timing indicator (TS38.212 7.3.1.2.1 to 3 sections). The terminal 2 can calculate the resource of an uplink control channel (PUCCH) for transmitting the HARQ-ACK (TS38.213 9.2.1 section). For example, in response to detection of downlink control information (DCI) for scheduling a downlink data channel (PDSCH), the terminal 2 may transmit HARQ-ACK information with the PUCCH. In this case, the terminal 2 calculates the number (index) of the PUCCH resource using r_PUCCH=|2·n_CCE,0/N_CCE|+2·ΔPRI. N_CCE, which is an index having a range of 0≤r_PUCCH≤15, is the number of CCEs in CORESET (Control Resource Set) of the control channel (PDCCH) in which the DCI is contained as described in Section 10.1. n_CCE, 0 is an index value of the head CCE of the PDCCH reception in which the DCI is detected, and ΔPRI is a value of the PUCCH Resource Indicator field notified by the DCI. Therefore, when receiving the resource of the PUCCH containing the ACK/NACK, the base station 3 can determine which PDCCH (or PDSCH) resource the ACK/NACK is for.

The base station 3 of the first embodiment transmits, to the terminal 2, a control channel or a data channel of the same content addressed to the moving terminal 2 using a plurality of candidate beams that is candidates. As a result, when the terminal 2 is present under any candidate beam, it is possible to receive the control channel or the data channel. Further, even when the terminal 2 moves across the area, the terminal 2 can prevent the communication link with the base station 3 from being interrupted and maintain the communication link as long as the terminal 2 is under the control of the candidate beam.

The base station 3 sets a plurality of beams that is candidates for the terminal 2 as candidate beams in the terminal 2. The base station 3 transmits a control channel and a data channel (a data channel having the same content and a control channel associated therewith) having the same content using a plurality of candidate beams which is candidate beams. The terminal 2 responds to the base station 3 by successfully detecting the control channel and successfully decoding the data channel with any of the candidate beams. Moreover, the base station 3 recognizes the position of the candidate beam in which the terminal 2 currently is present based on the candidate beam for which the terminal 2 has responded. Further, the base station 3 recognizes the candidate beam in which the terminal 2 currently is present, updates the candidate beams corresponding to the latest number of candidate beams from the recognized candidate beam, and sets the updated candidate beams in the terminal 2. As a result, a communication link between the base station 3 and the terminal 2 can be maintained.

It is assumed that the terminal 2 is present in the area of the beam B1 at the time of data reception, and moves to the area of the beam B2 at the time of return of the ACK/NACK due to successful detection of the control channel and successful decoding of the data channel transmitted with the beam B1. When the terminal 2 has also successfully received the control channel of the beam B2, the terminal 2 may return ACK/NACK with the resource for the response signal corresponding to the control channel and the data channel of the beam B2 regardless of whether the data channel of the beam B2 has been successfully decoded. The base station 3 can determine that the terminal 2 moves to the area of the beam B2 by detecting the ACK/NACK in the response signal resource, and can improve the followability to the movement of the terminal 2 by grasping more new information related to the location of the terminal 2.

The base station 3 of the present embodiment notifies the terminal 2 of information about the candidate beam. When the base station temporally changes the direction of the beam of the transmission signal to cover the communication area, it is conceivable to transmit the data signal in the time zone corresponding to the candidate beam. On the other hand, in the present embodiment, since the terminal 2 is notified of the information about the candidate beam, the temporal degree of freedom of transmitting the data signal is extended to the time zone allocated to all the candidate beams.

In addition, for convenience of description, the base station 3 selects a candidate beam to be allocated to the terminal 2 from among the plurality of candidate beams and notifies the terminal 2 of the selected candidate beam, but the base station 3 may generate a candidate beam to be allocated to each terminal 2 and can appropriately change the candidate beam.

Note that, in the single DCI mode of the Multi-TRP in the 5G system, the same data can be transmitted from two TRPs with the same setting (including encoding and the like). When beamforming is performed on two TRPs, two beams can be set, and two candidate beams can be created. Furthermore, in the multi-DCI mode of the multi-TRP, it is also possible to change communication parameters (encoding, modulation, and the like) for the same data. Therefore, as an example of the embodiment of the present disclosure, when the number of candidate beams is two, the present embodiment can be implemented using the Multi-TRP mechanism. In addition, by eliminating the limitation on the number of TRPs in the Multi-TRP, it is also possible to perform implementation without limitation on the number of candidate beams.

Note that, in the base station 3 of the first embodiment, the case where the MCSs of all the candidate beams are the same has been illustrated. However, a different MCS may be used for each candidate beams based on a candidate beam having a measurement report from the terminal 2 or a result of response of the terminal 2, and an embodiment thereof will be described below as the second embodiment. The same components as those in the first embodiment are denoted by the same reference numerals, and the description of the overlapping components and operations will be omitted.

### (b) Second Embodiment

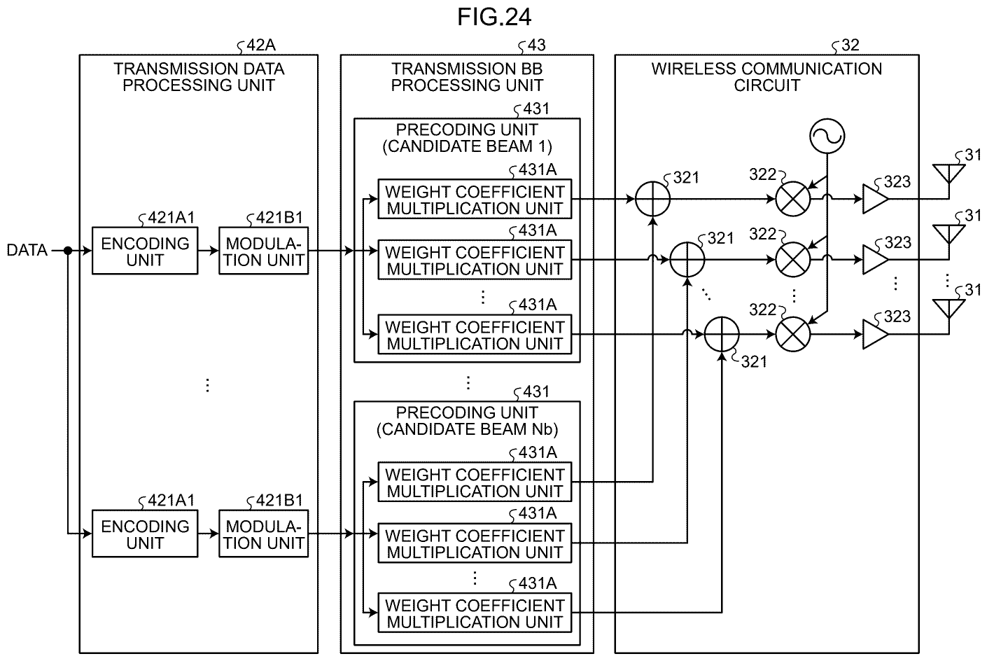

FIG. 24 is a block diagram illustrating an example of a functional configuration of a transmission data processing unit 42A, a transmission BB processing unit 43, and a wireless communication circuit 32 related to the base station 3 of the second embodiment. The transmission data processing unit 42 of the first embodiment is different from the transmission data processing unit 42A of the second embodiment in that an encoding unit 421A1 and a modulation unit 421B1 are disposed for each candidate beam.

The control unit 44 in the base station 3 determines the MCS for each candidate beam based on the candidate beam from which the measurement report from the terminal 2 or the result of response of the terminal 2 is received. Then, based on the encoding rate in the MCS set for each candidate beam, the control unit 44 sets the encoding rate of the encoding unit 421A1 corresponding to the candidate beam and sets the modulation scheme of the modulation unit 421B1 corresponding to the candidate beam.

In the base station 3 of the first embodiment, the case where the same MCS is applied to all the candidate beams for data transmission/reception has been exemplified. However, in the base station 3 of the second embodiment, it is not necessary to apply the same MCS, and the encoding rate and the modulation scheme of the data to be transmitted with each candidate beam can be set to be different based on the candidate beam for which the measurement report or the response from the terminal 2 is received. As a result, by assuming movement of the terminal 2 and determining the MCS so as to allow a change in the channel state or according to the report value of the channel state of each candidate beam, it is possible to increase the possibility that the terminal 2 moving across the beams can correctly decode data.

In the resource for mapping the control channel and the data channel according to the first embodiment, the control channel and the data channel for each candidate beam are mapped in the same transmission duration and the same system bandwidth. However, the present disclosure is not limited thereto, and the embodiment thereof will be described below as the third to fifth embodiments.

### (c) Third Embodiment

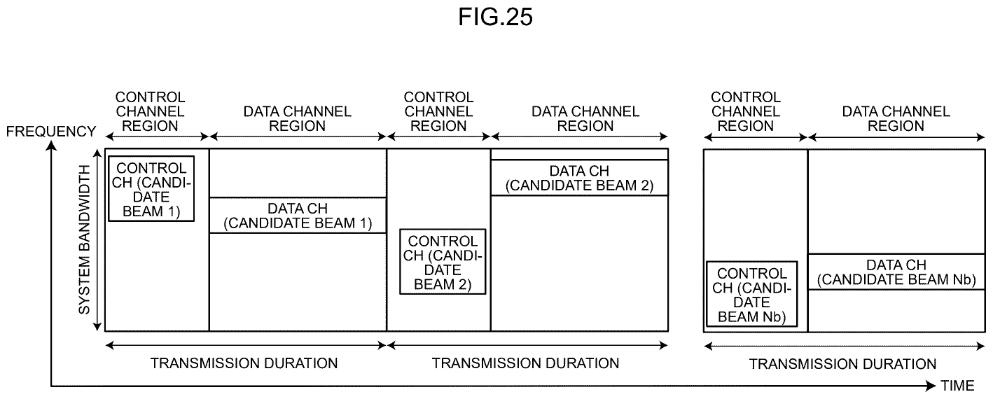

FIG. 25 is an explanatory diagram illustrating an example of the resource for mapping a control channel and a data channel of each candidate beam related to the base station 3 of the third embodiment. The base station 3 maps and transmits the control channel and the data channel of each beam candidate without limiting to the same transmission duration.

The terminal 2 attempts to detect a control channel in a search space common between beams within each transmission duration. Since different beamforming is applied to each control channel and each data channel and is transmitted to be intensified in different directions (beam areas), a receivable control channel and data channel change according to a position where the terminal 2 is present. The terminal 2 can receive only the control channel and the data channel of the candidate beam reaching the position where the terminal 2 is present.

### (d) Fourth Embodiment

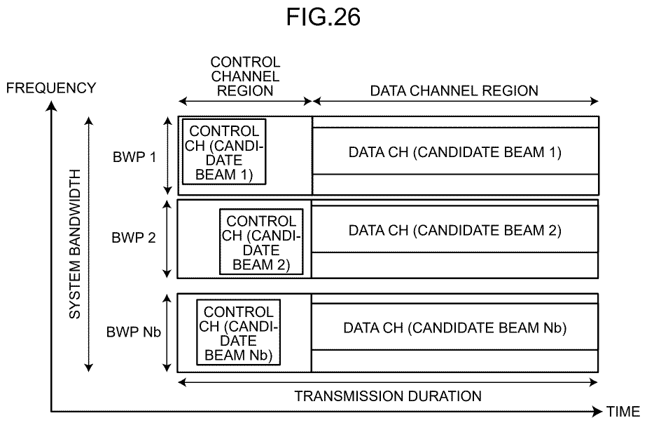

FIG. 26 is an explanatory diagram illustrating an example of the resource for mapping a control channel and a data channel of each candidate beam related to the base station 3 of the fourth embodiment. This is a form in which the operation (Bandwidth Adaptation) in which a system bandwidth is divided into a plurality of Bandwidth Parts (BWPs: sub-bands) and set in a communication band between the base station 3 and the terminal 2 is used. In such a form, a plurality of BWPs to be allocated to the terminal 2 is associated with the candidate beam, and the plurality of BWPs can be activated. The base station 3 transmits the control channel and the data channel of each beam candidate with the BWP in which the control channel and the data channel are allocated to the candidate beams.

The terminal 2 attempts to detect the control channel in the search space (region in which the control channel is monitored) of the BWP allocated to the terminal 2 and activated. Since different beamforming is applied to each control channel and each data channel and is transmitted to be intensified in different directions (beam areas), a receivable control channel and data channel change according to a position where the terminal 2 is present. Then, the terminal 2 can receive only the control channel and the data channel of the candidate beam corresponding to the BWP reaching the position where the terminal 2 is present.

Note that, in the related art (current standard), the number of BWPs that can be activated at one time for a specific terminal 2 is one band, but when the resource illustrated in FIG. 26 is used, the number of BWPs may be extended to a plurality of BWPs that can be activated at the same time. The association between the beam and the BWP is performed by the base station and is realized by notifying the terminal of the information of the association.

As a method by which the base station 3 sets the candidate beam in the terminal 2, a correspondence relationship between the BWP and the candidate beam is set in advance using higher layer signaling (for example, RRC signaling). Further, some of the plurality of candidate beams is activated using lower layer signaling (MAC signaling or physical layer signaling (L1 signaling)).

### (e) Fifth Embodiment

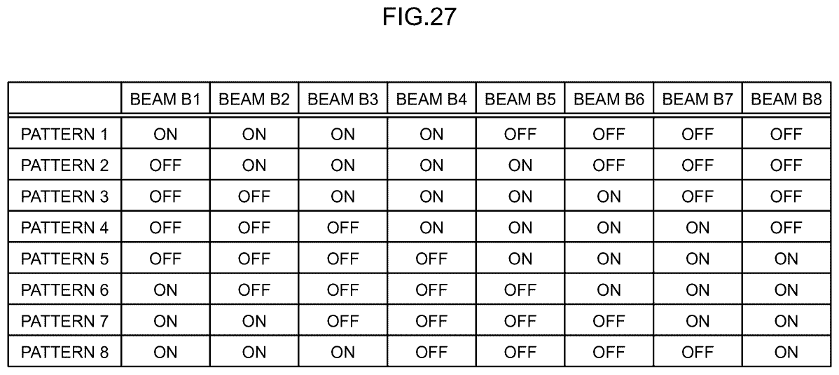

The fifth embodiment is an embodiment related to a method of making a notification of the setting of the candidate beam. Note that the method of setting the candidate beam is not limited to this regardless of whether the candidate beam is associated with the BWP, and the table illustrated in FIG. 27 may be used. FIG. 27 is an explanatory diagram illustrating an example of a table for managing a setting pattern for each candidate beam. The base station 3 defines and sets in advance a pattern of which beam(s) among the plurality of beams is/are turned on or off by higher layer signaling (for example, RRC signaling).

The base station 3 provides, for example, a 3-bit field using lower layer signaling (MAC signaling or physical layer signaling (L1 signaling)), and dynamically notifies the target terminal 2 of the pattern number in the field.

In the lower layer signaling, for example, in a case where 360 degrees is covered by 8 beams, the number of candidate beams (1 to 8) and information about which beam is turned on or off are used. Further, when a constraint that adjacent and continuous beams are turned on is provided, the indication of the number of candidate beams and the start point thereof enables unique determination. Therefore, 64 patterns may be indicated by a combination of the number of candidate beams (1 to 8) and the start points (1 to 8) thereof. In this case, the number of bits required for notification is 6 bits (8 bits are used when an any combination is allowed). Therefore, the base station 3 prepares in advance a table for managing a pattern for identifying ON/OFF for each beam, reads a pattern corresponding to a candidate beam, and notifies the terminal 2 of the read pattern.

Note that, in the example illustrated in FIG. 27, in a case where a constraint that the number of candidate beams is 4 is further provided, the required number of bits is 3 bits. Therefore, as illustrated in FIG. 27, the base station 3 prepares in advance a table for managing a pattern for identifying ON/OFF for each beam, reads a pattern corresponding to a candidate beam, and notifies the terminal 2 of the read pattern.

### (f) Sixth Embodiment

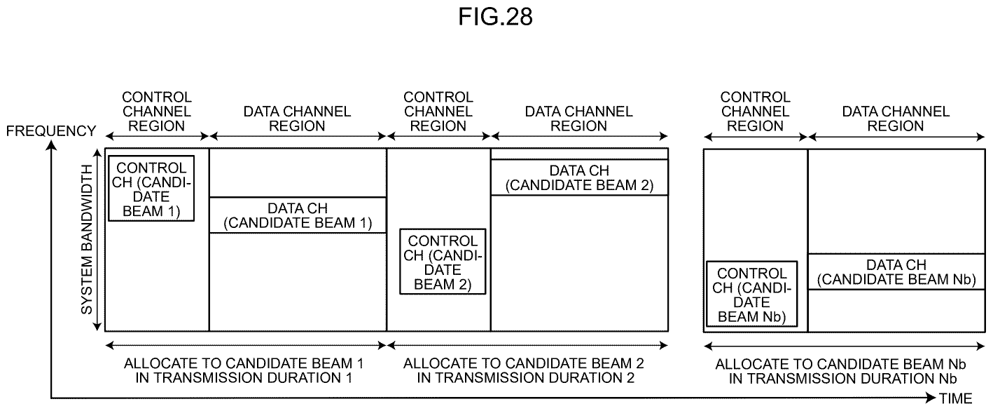

FIG. 28 is an explanatory diagram illustrating an example of the resource for mapping a control channel and a data channel of each candidate beam related to the base station 3 of the sixth embodiment. A relationship between a candidate beam and a transmission duration is clearly set on a one-to-one basis. The base station 3 transmits the control channel and the data channel of each beam candidate using the resource illustrated in FIG. 28.

The terminal 2 attempts to detect the control channel in a search space different for each transmission duration of the candidate beam. Since different beamforming is applied to each control channel and each data channel and is transmitted to be intensified in different directions (beam areas), a receivable control channel and data channel change according to a position where the terminal 2 is present. The terminal 2 can receive only the control channel and the data channel of the candidate beam reaching the position where the terminal 2 is present.

As a method by which the base station 3 sets the candidate beam in the terminal 2, a correspondence relationship between the transmission duration and the candidate beam is set in advance using higher layer signaling (for example, RRC signaling). Further, some of the plurality of candidate beams is activated using lower layer signaling (MAC signaling or physical layer signaling (L1 signaling)).

When the base station 3 of the first embodiment transmits the control channel and the data channel of each candidate beam in the same transmission duration, the terminal 2 determines that the pair of the control channel of successful detection and the data channel of successful decoding among the plurality of candidate beams is optimal. Then, the case where the ACK is returned using the resource for the response signal corresponding to the control channel associated with the data channel of successful decoding has been exemplified. An embodiment in a case where the base station 3 transmits the control channel and the data channel of the candidate beam in different transmission durations for each beam will be described below as the seventh embodiment.

### (g) Seventh Embodiment

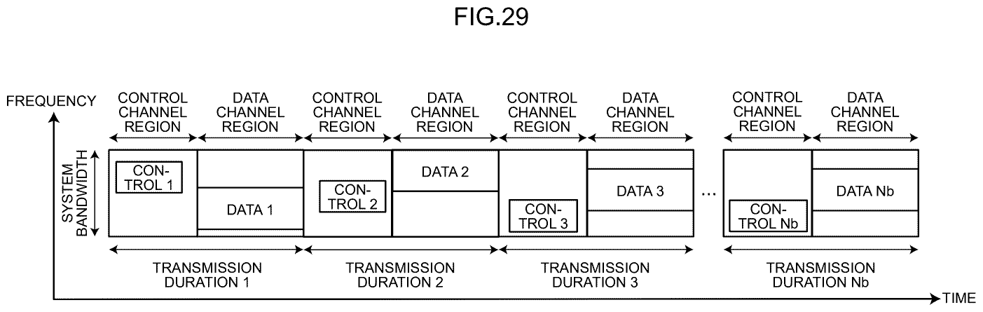

FIG. 29 is an explanatory diagram illustrating an example of the resource for mapping a control channel and a data channel of each candidate beam related to the base station 3 of the seventh embodiment. The base station 3 transmits the control channel and the data channel of each candidate beam in different transmission durations between the candidate beams. The base station 3 transmits the control channel and the data channel of each candidate beam in different transmission durations, such as the control channel (control 1) and the data channel (data 1) of the candidate beam B1 in the transmission duration 1, and the control channel (control 2) and the data channel (data 2) of the candidate beam B2 in the transmission duration 2.

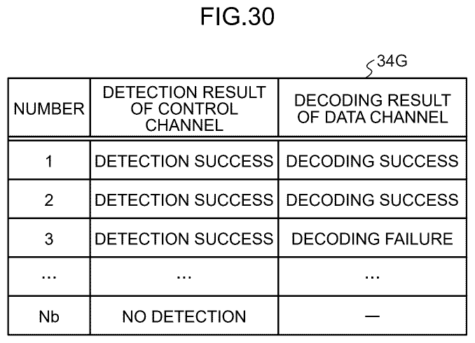

FIG. 30 is an explanatory diagram illustrating an example of a table 34G for managing the detection result of the control channel and the decoding result of the data channel for each candidate beam. Since the base station 3 transmits the control channel of each candidate beam in a different transmission duration, the terminal 2 receives each control channel in a different transmission duration. The terminal 2 can reflect the latest position of the terminal 2 by returning ACK to the control channel that has been detected successfully last time. However, for this purpose, the content of the data channel associated with each control channel is set to be the same.

For example, it is assumed that data channels to be transmitted in a certain section (a set of times (transmission durations 1 to Nb) allocated to beam candidates) are guaranteed to be the same. In this case, even when the decoding of the associated data channel is not successful, the terminal 2 returns the ACK with the response signal resource corresponding to the control channel that is successfully detected in the last transmission duration in the section, for example, the control channel (control 3) illustrated in FIG. 29.

For example, it is assumed that data channels to be transmitted in a certain section (a set of times (transmission durations 1 to Nb) allocated to beam candidates) are not guaranteed to be the same. In this case, the terminal 2 returns the ACK with the response signal resource corresponding to a control channel associated with the data channel that is successfully decoded, for example, the control channel (control 2) illustrated in FIG. 29.

Furthermore, in a case where the terminal 2 has successfully decoded a plurality of data channels and the content is the same, the terminal 2 returns the ACK with a response signal resource corresponding to a pair of a control channel and a data channel in a later transmission duration, for example, the control channel (control 2).

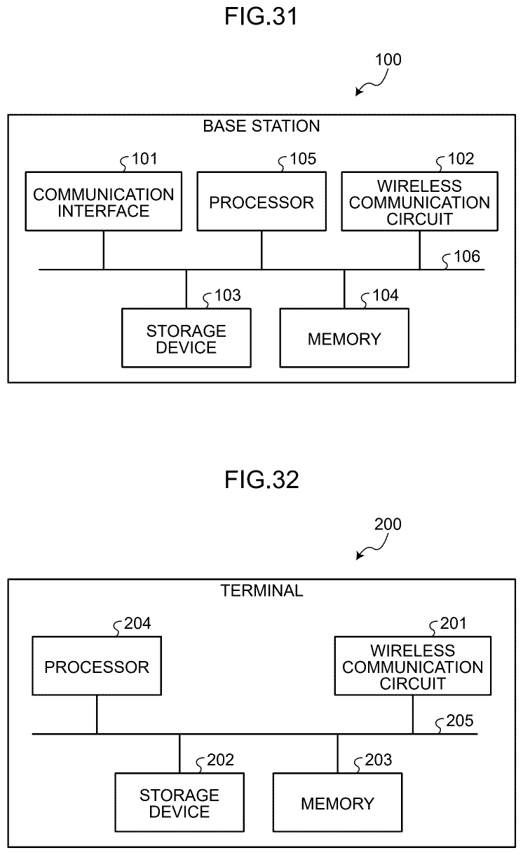

FIG. 31 is a block diagram illustrating an example of a hardware configuration of a base station 100. The base station 100 illustrated in FIG. 31 includes a communication interface 101, a wireless communication circuit 102, a storage device 103, a memory 104, a processor 105, and a bus 106. The base station 100 corresponds to the base station 3 illustrated in FIG. 3. The communication interface 101 corresponds to the communication interface 33 that communicates with and connects to the core network. The wireless communication circuit 102 corresponds to the wireless communication circuit 32. The storage device 103 stores content of processing executed by the processor 105. The memory 104 stores information being processed by the processor 105. The processor 105 executes, for example, the functions of the reception BB processing unit 41, the transmission data processing unit 42, the transmission BB processing unit 43, and the control unit 44. Specifically, the processor 105 executes the functions of the setting unit 51, the transmission unit 52, the reception unit 53, the update unit 54, and the notification unit 55. The bus 106 is a bus that transmits data between the communication interface 101, the wireless communication circuit 102, the storage device 103, the memory 104, and the processor 105.

The base station 100 sets a plurality of beams that is candidates for the terminal 2 as candidate beams in the terminal 2. The base station 100 transmits a control channel and a data channel having the same content using a plurality of beams which is candidate beams. The base station 100 receives, from the terminal 2, a response signal to a candidate beam for successful detection of a control channel and successful decoding of a data channel. The base station 100 recognizes the position of the candidate beam in which the terminal 2 currently is present based on the candidate beam corresponding to the response signal. Further, the base station 100 recognizes the candidate beam in which the terminal 2 currently is present, updates the candidate beams corresponding to the latest number of candidate beams from the recognized candidate beam, and sets the updated candidate beams in the terminal 2. As a result, a communication link between the base station 100 and the terminal 2 can be maintained.

In the block diagram illustrating the functional configuration of the base station in FIG. 3 and the block diagram illustrating the hardware configuration of the base station in FIG. 31, the functions of the base station are implemented by a single device, but these are merely examples, and the functions of the base station may be implemented by a plurality of devices by dividing the functions into several units (for example, a function of a relatively high layer in the baseband signal process, a function of a relatively low layer in the baseband signal process, a function related to the wireless signal process, and the like).

FIG. 32 is a block diagram illustrating an example of a hardware configuration of a terminal 200. The terminal 200 illustrated in FIG. 32 includes a wireless communication circuit 201, a storage device 202, a memory 203, a processor 204, and a bus 205. The terminal 200 corresponds to the terminal 2 illustrated in FIG. 2. The wireless communication circuit 201 corresponds to the wireless communication circuit 12. The storage device 202 stores content of processing executed by the processor 204. The memory 203 stores information being processed by the processor 204. The processor 204 executes, for example, the functions of the reception BB processing unit 21, the transmission data processing unit 22, the transmission BB processing unit 23, and the control unit 24. Specifically, the processor 204 executes the functions of the setting unit 61 and the transmission unit 62. The bus 205 is a bus that transmits data between the wireless communication circuit 201, the storage device 202, the memory 203, and the processor 204.

The terminal 200 is set by the base station 3 with a plurality of beams that is candidates for the terminal 200 as candidate beams for signal transmission/reception. When receiving a signal transmitted from the base station 3 using a plurality of beams which is candidate beams, the terminal 200 transmits a response signal to the base station 3 using a response signal resource corresponding to a candidate beam of the received signal. As a result, a communication link between the base station 3 and the terminal 200 can be maintained.

According to an aspect, a communication link between a terminal device and a base station device is maintained.

All examples and conditional language recited herein are intended for pedagogical purposes of aiding the reader in understanding the disclosure and the concepts contributed by the inventors to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A base station device that wirelessly communicates with a terminal device, the base station device comprising processor circuitry configured to:
set a plurality of beams that candidates for the terminal device as candidate beams for signal transmission/reception;
transmit a signal having a same content using the plurality of beams that is the candidate beams;
receive a response signal from the terminal device that has received the signal transmitted using any beam of the plurality of beams; and
update the candidate beams.

2. The base station device according to claim 1, wherein the processor circuitry is further configured to notify the terminal device of information about the set candidate beams.

3. The base station device according to claim 1, wherein
the processor circuitry is configured to set encoding and modulation scheme according to each of the plurality of beams to be transmitted even when the signal has the same content when the signal is transmitted, and execute encoding and modulation of the signal based on the set encoding and modulation scheme.

4. The base station device according to claim 1, wherein
the processor circuitry is configured to recognize a beam corresponding to a position where the terminal device is present based on the response signal.

5. The base station device according to claim 1, wherein
the processor circuitry is configured to update the candidate beam based on a control signal resource used to transmit the response signal.

6. The base station device according to claim 1, wherein
the processor circuitry is configured to receive a response signal from the terminal device that has successfully decoded the signal.

7. The base station device according to claim 1, wherein
the processor circuitry is configured to receive a response signal from the terminal device that has detected a control channel of the signal.

8. A terminal device that wirelessly communicates with a base station device, the terminal device comprising processor circuitry configured to:
set a plurality of beams that candidates for the terminal device as candidate beams for signal transmission/reception and is set by the base station device; and
transmit, when receiving a signal transmitted from the base station device using the plurality of beams that is the candidate beams, a response signal to the base station device using a response signal resource corresponding to a candidate beam of the received signal.

9. A wireless communication system comprising:
a terminal device; and a base station device that wirelessly communicates with the terminal device, wherein
the base station device includes first processor circuitry configured to:
set a plurality of beams that candidates for the terminal device as candidate beams for signal transmission/reception,
transmit a signal having a same content using the plurality of beams that is the candidate beams,
receive a response signal from the terminal device that has received the signal transmitted using any beam of the plurality of beams, and
update the candidate beam, and
the terminal device includes second processor circuitry configured to:
transmit, when receiving the signal transmitted using the candidate beam from the base station device. the response signal to the base station device using a response signal resource corresponding to a candidate beam of the received signal.
